(19) United States
(12) Patent Application Publication
(10) Pub. No.: US 2005/0029778 A1
(43) Pub. Date: Feb. 10, 2005

(54) Mounting bracket with fastener retention

(76) Inventors: Robert Weber, Windsor (CA); David L. Dominssini, Allen Park, MI (US)

Correspondence Address: Sally J. Brown;AUTOLIV ASP, INC., 3350 Airport Road, Ogden, UT, 84405, US

(21) Appl. No.: 10/635,686

(22) Filed: Aug. 6, 2003

(51) Int. Cl. B60R 21/16; B60R 21/22

(52) U.S. Cl. 280/728.2; 280/730.2

(57) ABSTRACT

A mounting bracket capable of retaining a fastener that may be used to mount a curtain airbag and/or a tether to a vehicle is disclosed. The mounting bracket has a front face and a rear face positioned behind the front face. A first opening is added to the front face and a second opening is added to the second face. The first opening and the second opening are constructed such that a fastener may pass through the mounting bracket via the first opening and the second opening. The mounting bracket also has a retaining member that is constructed such that if the fastener passes through the mounting bracket, the fastener engages the retaining member and causes the mounting bracket to retain the fastener. The retaining member may additionally have retaining tabs and centering tabs positioned on the rear face proximate the second opening. An anti-rotation tab may additionally be added to the mounting bracket.

### BACKGROUND OF THE INVENTION

1. Field of the Invention

The present invention relates to attaching an airbag to the interior of a vehicle. More specifically, the present invention relates to a novel mounting bracket capable of retaining a fastener that may be used to mount an airbag and/or a tether to a vehicle.

2. Description of Related Art

Inflatable airbags are well accepted for use in motor vehicles and have been credited with preventing numerous deaths and injuries. In fact, the inclusion of inflatable safety restraint devices, or airbags, is now a legal requirement for many new vehicles. Airbags are typically installed throughout the passenger cabin of a vehicle, including the steering wheel. In the event of an accident, an accelerometer within the vehicle measures the abnormal deceleration and triggers the expulsion of rapidly expanding gases from an inflator. The expanding gases fill the airbags, which quickly inflate in front of the driver and passenger to protect them from impact against the windshield, dashboard, steering wheel, or other portions of the vehicle. Side impact airbags, such as curtain airbags, have also been developed in response to the need for protection from impacts in a lateral direction or against the side of the vehicle.

Recently, airbag technology has continued to advance such that curtain airbags are now enlisted to provide roll-over protection. During a roll-over accident, the vehicle occupants can be jostled considerably, thereby causing the occupant to impact various parts of the vehicle interior. Even worse, the occupant may be ejected from the vehicle. Alternatively, a head or limb of an occupant may extend outside the vehicle during the roll-over. Such “occupant excursion” during roll-over accidents is a common cause of automotive fatality, particularly in the case of vehicle occupants that are not wearing a seat belt during the roll-over.

Conventional curtain airbags attempt to combat the dangers of side impact or roll-over accidents by having a curtain airbag unroll or unfold downward from the roof of the vehicle and then inflate beside the person as a means of preventing the person from hitting the door, the window, or the side of the vehicle during lateral impact. Since a vehicle occupant may be leaning forward, reclined in the seat, or at any position in between, such airbags are typically long enough to cover the whole interior side of the vehicle, protecting occupants in both the front and rear occupant seats.

Generally, the curtain airbags must be sized to hold large volumes of inflation gas and descend below the window sill. Consequently, when not inflated the curtain airbag includes a significant amount of material. This material is then rolled, folded, or otherwise gathered to form a tight, tubular bundle. A sock that fits around the curtain is also added to ensure that the curtain airbag is kept rolled or folded.

The curtain is stored and mounted either on or proximate a roof rail of the vehicle. Such mounting is generally accomplished via a two-step process. First, the curtain must be held in the proper position. This can be done by either having multiple workers hold the airbag or by attaching the airbag to sophisticated jigs, hooks, or mounting brackets (collectively “brackets”) that have been placed into slots in the body of the vehicle. Once the curtain airbag has been secured in the proper location, the workers are free to affix the curtain airbag assembly to the vehicle using fasteners such as bolts, screws, rivets, and the like. Usually these fasteners are threaded into holes, slits, or apertures that have been put into the top of the curtain airbag to facilitate the assembly process.

However, in order for this two-step process to properly mount the curtain airbag, steps must be taken to ensure that the bracket adequately retains the fasteners. Thus, a retaining washer or other retaining component must be added. These retaining washers are made of spring steel and comprise a ring or ring-like structure that is positioned around a portion of the fastener. This retaining washer must be added to the system before the bracket is affixed to the vehicle.

Unfortunately, the use of such retaining washers creates significant disadvantages for airbag manufacturers. For example, retaining washers increase the total number components required to produce the airbag. As a result, airbag manufacturers are forced to expend additional resources to produce, design, and/or install the airbag system. Moreover, adding a retaining washer to the curtain airbag assembly also increases the time required to complete the installation process. Retaining washers are usually very small components, and as such, airbag installers often waste precious seconds and/or minutes trying to properly position the retaining washer around the fastener. As manufacturers incur costs for every moment that passes during the manufacturing process, these wasted seconds or minutes can significantly affect the total production costs and the manufacturer's overall profit margin.

Retaining washers also limit the type of the fastener that may be used during installation. As the retaining washer must surround a portion of the fastener, only those fasteners having a diameter, width, and shape that corresponds to the size of the retaining washer may be used to mount the airbag. As a result, the ability of manufacturers to change the size or shape of the fastener to accommodate for various spatial or production constraints is significantly reduced.

In addition to the problems associated with the use of retaining washers, many known brackets have an additional defect in that they fail to compensate for the rattling and vibrations associated with the normal operation of the vehicle. Over the course of time, such rattling and vibrations can loosen and/or disconnect the fastener and the bracket from the vehicle. Such loosening or disconnecting of the fastener and the bracket is undesirable and may prevent the curtain airbag assembly from properly functioning during a crash.

Recently, some airbag manufacturers have attempted to prevent the loosening and/or disconnecting of the fastener and the brackets from the vehicle by employing shoulder bolts or other sophisticated fasteners. Such fasteners have been specifically designed to ensure that the fastener and the bracket remain permanently affixed to the vehicle. Although some of these systems have been successful in permanently attaching the fastener and bracket, the shoulder bolts and other sophisticated fasteners required by these systems are often difficult to use and/or expensive to produce. As such, the production costs associated with using these sophisticated fasteners are drastically increased.

Accordingly, there is a need in the art for a mounting bracket that addresses and/or solves one or more of the above-listed limitations. Such a device is disclosed herein.

### SUMMARY OF THE INVENTION

The apparatus of the present invention has been developed in response to the present state of the art, and in particular, in response to the problems and needs in the art that have not yet been fully solved by currently available mounting brackets. In accordance with the invention as embodied and broadly described herein in the preferred embodiment, a mounting bracket that may be used to mount a curtain airbag and/or one or more tethers to a vehicle is provided. According to one embodiment, the mounting bracket is made of steel or pre-coated steel and may be attached to a vehicle through the use of one or more fasteners such as bolts, screws, or the like.

In general, the mounting bracket is a sheet or plate that has been bent or otherwise configured such that it comprises two faces: a front face and a rear face. The rear face is positioned behind the front face. The mounting bracket is constructed such that all or a portion of an airbag and/or a tether may be enclosed between the front face and the rear face.

The mounting bracket further comprises a first opening and a second opening. The first opening is located on the front face and the second opening is located on the rear face. Preferably, the second opening is positioned behind the first opening. The first opening and the second opening are sized such that one or more fasteners may pass through the mounting bracket via the first opening and the second opening.

The mounting bracket of the present invention is designed such that it is capable of retaining a fastener. Thus, the mounting bracket comprises one or more retaining members. The one or more retaining members are constructed such that if the fastener passes through the mounting bracket, the fastener engages the retaining member and causes the mounting bracket to retain the fastener.

In some embodiments, the retaining member may comprise one or more retaining tabs. The retaining tabs are positioned on the rear face of the mounting bracket proximate the second opening. Preferably, the retaining tabs are constructed such that if the fastener passes through the mounting bracket, the fastener contacts and/or pushes apart the retaining tabs and causes the mounting bracket to retain the fastener.

Additional embodiments may be made in which the retaining tabs are angled. Preferably, this is accomplished by bending or otherwise configuring the retaining tabs such that the retaining tabs form an angle with respect to the rear face. The measure of the angle formed between the retaining tabs and the rear face may be from about 3° to about 35°.

The retaining member may further be constructed to include one or more centering tabs. The centering tabs are positioned on the rear face proximate the retaining tabs. Preferably, the position of the centering tabs is selected such that the centering tabs and the retaining tabs surround the second opening.

Preferably, the centering tabs are capable of guiding a fastener. More specifically, the centering tabs are constructed such that if the fastener passes through the mounting bracket, the centering tabs guide the fastener to ensure that the fastener contacts and/or pushes apart the retaining tabs.

As with the retaining tabs, embodiments may be constructed in which the centering tabs are angled. Preferably, this is accomplished by bending or otherwise configuring the centering tabs such that the centering tabs form an angle with respect to the rear face. The measure of the angle formed between the centering tabs and the rear face may be from about 45° to about 70°.

In addition to the retaining member, the mounting bracket of the present invention may further comprise one or more anti-rotation tabs. The anti-rotation tabs are flaps, tabs, or extensions that extend rearward from the mounting bracket. Preferably, the anti-rotation tabs are attached to the rear face and are designed such that they are capable of being inserted into an aperture or opening that is located on a vehicle.

The anti-rotation tabs may further be constructed such that if the mounting bracket is installed on a vehicle, the anti-rotation tabs prevent the mounting bracket from rotating. More specifically, if the mounting bracket is affixed to a vehicle, the anti-rotation tabs engage the vehicle and prevent the mounting bracket from rotating or spinning.

These and other features and advantages of the present invention will become more fully apparent from the following description and appended claims.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of the interior of a vehicle in which one embodiment of the mounting bracket of the present invention is used to attach a curtain airbag and a tether to a vehicle;

FIG. 2 is a perspective view of the front side of the mounting bracket of the present invention;

FIG. 3 is a perspective view of the backside of the mounting bracket of the present invention;

FIG. 4 is a partially cutaway perspective view of the side of mounting bracket of the present invention;

FIG. 5 is a cross-sectional view of the mounting bracket of the present invention used to enclose a portion of a curtain airbag; and

FIG. 6 is a cross-sectional view of the mounting bracket of the present invention used to mount a curtain airbag to a vehicle.

### DETAILED DESCRIPTION OF THE PREFERRED EMBODIMENTS

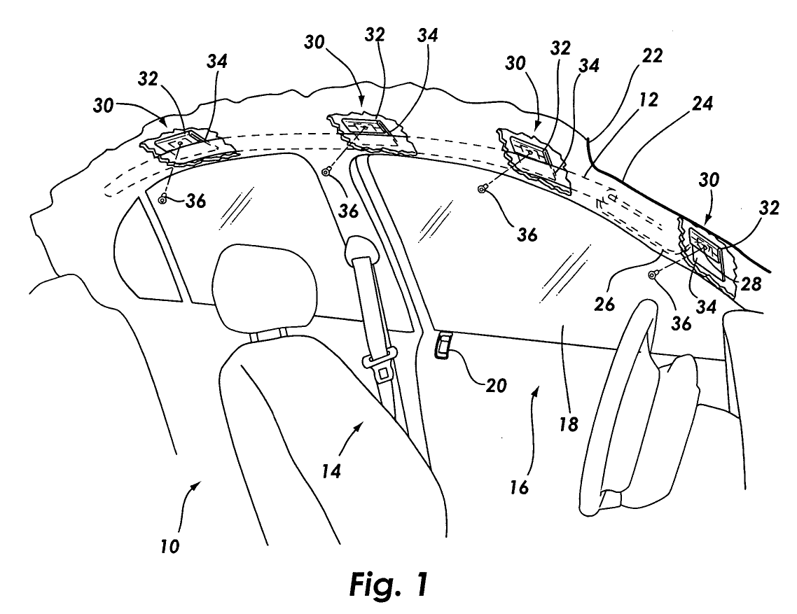

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 6, is not intended to limit the scope of the invention, as claimed, but is merely representative of presently preferred embodiments of the invention.

Referring to FIG. 1, the interior of a vehicle 10 is depicted with an attached side curtain inflatable airbag 12. The side curtain airbag 12 is attached to an inflator (not shown) that provides inflation gas, and a sensor (not shown) that provides an initiation signal to initiate inflation of the curtain airbag 12 when an accident occurs.

Generally, the curtain airbag 12 is stored along a roof rail (not shown) of the vehicle 10. The curtain airbag 12 is designed to inflate and substantially cover the lateral side 14, the door 16, the window 18, and the lock switch 20 when an accident occurs. Because the size of the roof rail is generally kept to a minimum to provide an aesthetic vehicle interior and to accommodate larger windows, the curtain airbag 12 is usually folded, rolled or otherwise gathered into a bundle having dimensions similar to those of the roof rail before installation on the vehicle.

As the roof rail and the curtain airbag 12 are often not visually appealing to the customer, a vehicle headliner 22 and/or decorative trim 24 are usually added to increase the aesthetic attractiveness of the vehicle interior 10. The headliner 22 is generally added to cover the roof of the vehicle while the edges of the headliner 22 descend to mask the area inboard of the roof rail. If the design of the vehicle interior 10 is such that the roof rail is not completely covered by the headliner 22, the decorative trim 24 may be used to further cover the roof rail or the curtain airbag 12.

The cushion airbag 12 may also be connected to one or more tethers 26 that extend from the cushion airbag 12 to one or more anchoring points 28 positioned on the interior of vehicle 10. The tethers 26 are designed to exert tension on the inflated curtain airbag 12 to keep the inflated curtain airbag 12 generally between the vehicle occupants and the lateral side 14 of the vehicle 10.

The curtain airbag 12 and the tethers 26 are secured to the vehicle 10 to ensure that the 21 curtain airbag 12 maintains a preferred position and orientation during deployment as well as during the normal operation of the vehicle. Thus, one or more mounting brackets 30 are added to mount the curtain airbag 12 and the tethers 26 to the vehicle 10.

The mounting brackets 30 generally comprise two faces: a front face 32 and a rear face 34. The rear face 34 is positioned behind the front face 32. Preferably, mounting brackets 30 are made of metal such as steel or pre-coated steel. However, plastic and/or other materials that are capable of supporting the curtain airbag 12 and/or the tethers 26 may also be used.

The mounting brackets 30 are designed such that a portion of the curtain airbag 12 and/or the tethers 26 may be enclosed between the front face 32 and the rear face 34. Once the curtain airbag 12 and/or the tethers 26 have been enclosed between the front face 32 and the rear face 34, the curtain airbag 12 and/or the tethers 26 may be mounted to the vehicle 10. Preferably, this is accomplished to through the use of one of more fasteners 36 that are constructed to pass through the mounting brackets 30. These fasteners 36 can be selected from any of the types of fasteners known in the art, including bolts, screws, and/or other members designed to connect the curtain airbag 12 and/or the tethers 26 to the vehicle 10.

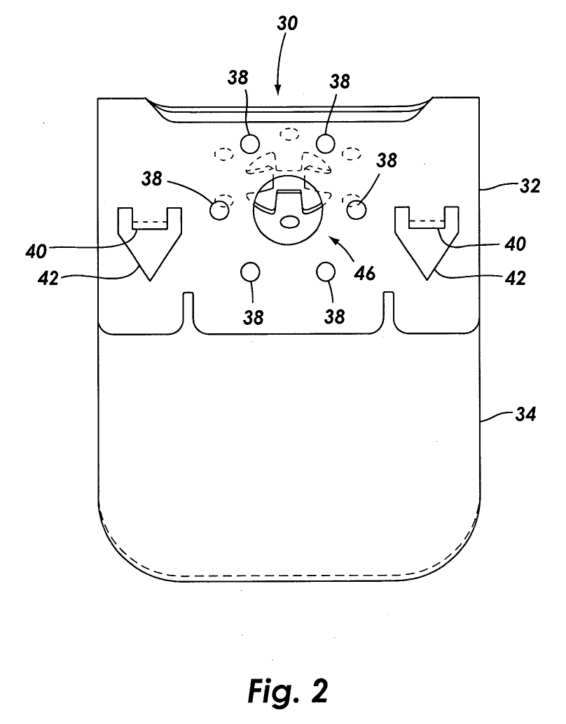

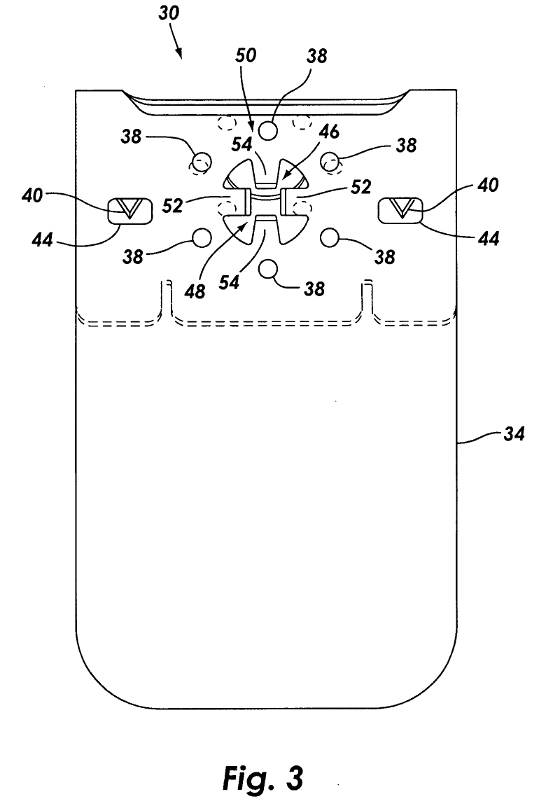

Referring to FIGS. 2 and 3, an embodiment of a mounting bracket 30 of the present invention is illustrated in greater detail. Specifically, FIG. 2 shows the front side of the mounting bracket 30 whereas FIG. 3 shows the backside of the mounting bracket 30.

In general, the mounting bracket 30 comprises a metal sheet or plate that has been bent or otherwise configured such that it comprises two faces: a front face 32 and a rear face 34. The rear face 34 is positioned behind the front face 32. The mounting bracket 30 is constructed such that all or a portion of the airbag (shown in FIG. 1) and/or the tethers (shown in FIG. 1) may be enclosed between the front face 32 and the rear face 34.

To ensure that the airbag and/or the tethers are properly enclosed between the front face 32 and the rear face 34, the mounting bracket 30 may further include one or more depressions 38 and/or one or more closing tabs 40. Preferably, the closing tabs 40 are pointed tabs or flaps that extend rearward from the front face 32 towards the rear face 34 as illustrated in FIG. 3. However, other shapes and/or configurations of the closing tabs 40 may also be used.

Additionally, the mounting bracket 30 may further comprise one or more apertures 42 and/or one or more slits 44. The apertures 42 are located on the front face 32 adjacent to the closing tabs 40. Conversely, the slits 44 are positioned on the rear face 34 and are sized such that they are capable of receiving the closing tabs 40.

The mounting bracket 30 is constructed such that the fasteners (shown in FIG. 1) may pass through the mounting bracket 30. Thus, the mounting bracket 30 comprises a first opening 46 and a second opening 48. The first opening 46 is located on the front face 32 and the second opening 48 is located on the rear face 34. Preferably, the second opening 48 is positioned behind the first opening 46. The size, shape, and configuration of the first opening 46 and the second opening 48 is selected such that the fasteners may pass through the mounting bracket 30 via the first opening 46 and the second opening 48.

The mounting bracket 30 is capable of retaining a fastener. Accordingly, the mounting bracket 30 comprises one or more retaining members 50. Preferably, the retaining members are added to the mounting bracket 30 on the rear face adjacent to the second opening 48. The retaining members 50 are constructed such that if the fasteners pass through the mounting bracket 30, the fasteners engage the retaining members 50 and cause the mounting bracket 30 to retain the fasteners.

Referring specifically to FIG. 3, the embodiment of the retaining member 50 will be described in greater detail. The retaining member 50 comprises one or more retaining tabs 52. The retaining tabs 52 are constructed such that if the fasteners (shown in FIG. 1) pass through the mounting bracket 30, the fasteners contact and/or push apart the retaining tabs 52 and cause the mounting bracket 30 to retain the fasteners.

In some embodiments, the retaining tabs 52 may be angled. This may be accomplished by bending or otherwise constructing the retaining tabs 52 away from the first opening 46 such that the retaining tabs 52 form an angle with respect to the rear face 34. Preferably, the measure of the angle between the retaining tabs 52 and the rear face 34 is from about 3° to about 35°. However, other angles and/or configurations of the retaining tabs 52 may also be used.

The retaining member 50 may further comprise one or more centering tabs 54. The centering tabs 54 are positioned on the rear face 34 proximate the retaining tabs 52. Preferably, the position of the centering tabs 54 is selected such that the centering tabs 54 and the retaining tabs 52 surround or encircle the second opening 48.

The centering tabs 54 are constructed such that they are capable of guiding the fasteners. More specifically, the centering tabs 54 are configured such that if the fasteners pass through the mounting bracket 30, the centering tabs 54 guide the fasteners to ensure that the fasteners contact and/or push apart the retaining tabs 52.

As with the retaining tabs 52, embodiments of the retaining member 50 may be constructed in which the centering tabs 54 are angled. This may be accomplished by bending or otherwise constructing the centering tabs 54 away from the first opening 46 such that the centering tabs 54 form an angle with respect to the rear face 34. Preferably, the measure of the angle between the centering tabs 54 and the rear face 34 is from about 45° to about 70°. Of course, other angles and/or configurations of the centering tabs 54 may also be used. Yet further embodiments may be made in which the centering tabs 54 are perpendicular or substantially perpendicular to the rear face 34 such that the centering tabs 54 may center and/or retain a fastener (shown in FIG. 1) within the bracket 30.

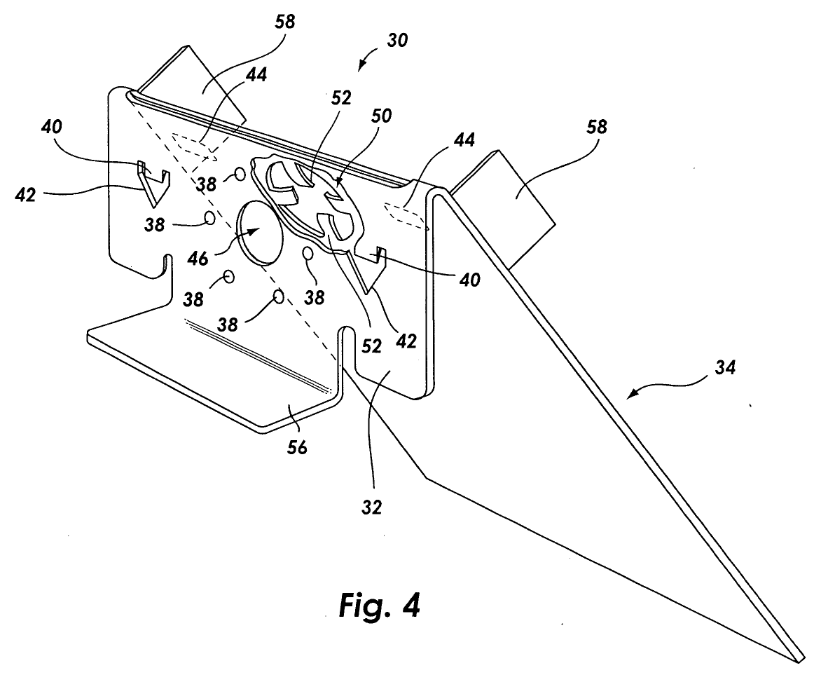

In the embodiment shown in FIG. 3, the retaining member 50 comprises two retaining tabs 52 and two centering tabs 54. However, other embodiments may be made in which the number, position, shape and/or orientation of the retaining tabs 52 and/or the centering tabs 54 differs from that which is shown in FIG. 4. For example, some embodiments may be made with only one retaining tab 52 and/or only one centering tab 54. Similarly, other embodiments may have more than two retaining tabs 52 and/or more than two centering tabs 54. Still further embodiments may be made in which the retaining member 50 comprises some other feature and/or combination of features that are capable of retaining a fastener.

By constructing the mounting bracket 30 with one or more retaining members 50, significant advantages may be achieved over the prior art. For example, by including a retaining member 50, the present invention eliminates the need to use a retaining washer or other separate retaining component. As such, the total number of parts needed as part of the airbag system is reduced. Additionally, by constructing a mounting bracket that is capable of retaining a fastener, the present invention also decreases the time necessary to assemble or install the airbag system as the airbag installer will no longer be required to waste time fumbling with retaining washers or other tiny parts. Moreover, by eliminating the retaining washer, the present invention also allows airbag manufacturers the ability to use the mounting brackets 30 with fasteners of varying diameters, widths, and/or shapes.

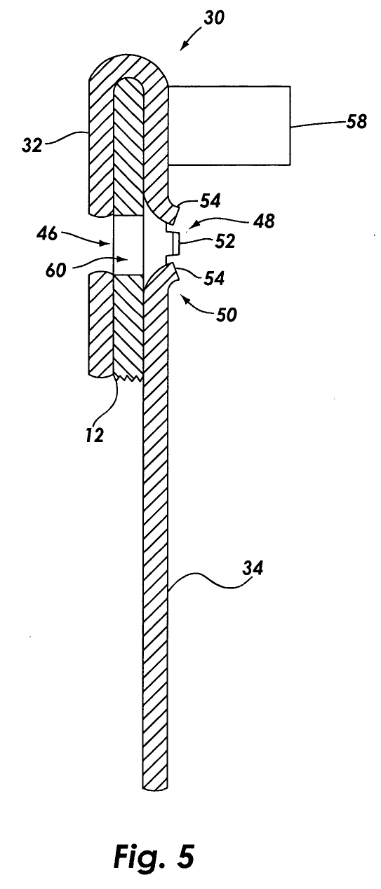

Referring now to FIG. 4, a partially cutaway perspective view of the side of the mounting bracket 30 of the present invention is depicted. As seen in FIG. 5, the mounting bracket 30 may further comprise an extending flange 56. The extending flange 56 is a flap or tab that is added to the front face 32. Preferably, the extending flange 56 extends outwardly away from the rear face 34 such that it may support or engage the airbag (shown in FIG. 1) and/or the tethers (shown in FIG. 1).

As seen in FIG. 4, the mounting bracket 30 may additionally comprise one or more anti-rotation tabs 58. The anti-rotation tabs 58 generally comprise flaps, tabs, or extensions that extend rearwards from the mounting bracket 30. Preferably, the anti-rotation tabs 58 are attached to the rear face 34 and are designed such that they are capable of being inserted into an aperture or opening located on a vehicle.

The anti-rotation tabs 58 are constructed such that if the mounting bracket 30 is installed on a vehicle, the anti-rotation tabs 58 prevent the mounting bracket 30 from rotating. More specifically, if the mounting bracket 30 is mounted on a vehicle, the anti-rotation tabs 58 engage the vehicle and prevent the mounting bracket 30 from rotating or spinning when a torque or force is applied.

In the embodiment shown in FIG. 4, two anti-rotation tabs 58 are attached to the rear face 34 proximate the top of the mounting bracket 30. However, other embodiments may be made in which the number, configuration, shape, and/or position of the anti-rotation tabs 58 differs from that which is shown in FIG. 4. For example, embodiments may be made having only one anti-rotation tab 58. Still other embodiments may have more than two anti-rotation tabs 58. Yet, further embodiments may position the anti-rotation tabs 58 on or proximate to the middle and/or the bottom of the rear face 34. Even further embodiments may position the anti-rotation tabs 58 on or proximate to the front face 32.

By configuring the mounting bracket 30 with one or more anti-rotation tabs 58, significant advancements may be achieved over many previously known mounting brackets. Specifically, by adding the anti-rotation tabs 58, the present invention engages the vehicle and prevents the rattlings and vibrations associated with normal operation of the vehicle from loosening or disconnecting the fastener and/or the mounting bracket. As such, the need to use expensive shoulder bolts or other sophisticated fasteners to permanently attach the airbag to the vehicle is effectively eliminated.

Referring now to FIG. 5, a cross-sectional view of the mounting bracket 30 is depicted. More specifically, FIG. 5 is a cross-sectional view of the embodiment of the mounting bracket 30 shown in FIG. 4 that is being used to enclose a portion of the curtain airbag 12. The curtain airbag 12 is enclosed between the front face 32 and the rear face 34. Of course, in a similar manner, the mounting bracket 30 may also enclose a portion of the tethers (shown in FIG. 1) between the front face 32 and the rear face 34.

In FIG. 5, the curtain airbag 12 includes one or more holes 60. These holes 60 are apertures, openings, or slits in the curtain airbag 12. Preferably the holes 60 are positioned on the curtain airbag 12 such that when the curtain airbag 12 is enclosed between the front face 32 and the rear face 34, the position of the holes 60 corresponds to the position of the first opening 46.

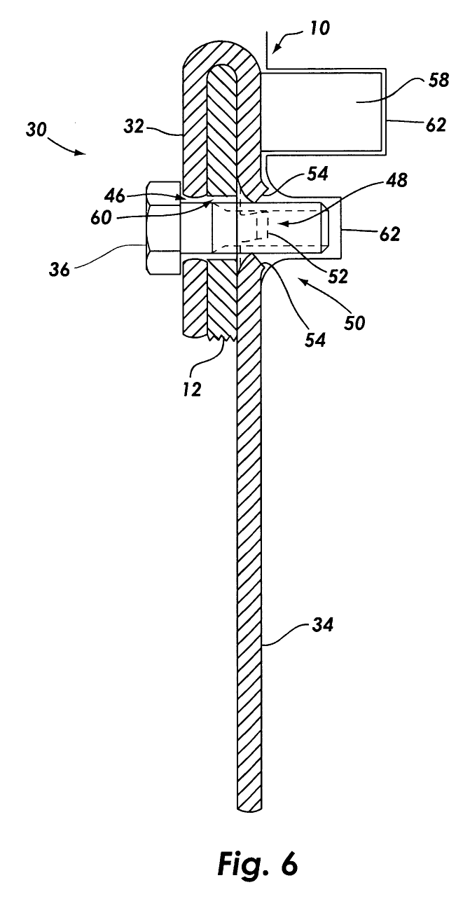

Referring now to FIG. 6, the manner in which the mounting bracket 30 may operate to mount a curtain airbag and/or a tether to a vehicle is depicted. Specifically, FIG. 6 shows the cross-sectional view of FIG. 5 used to mount the curtain airbag 12 to a portion of the vehicle 10. Of course, as noted above, the mounting bracket 30 may also be used in a similar manner to mount the one or more tethers (shown in FIG. 1) to the vehicle 10.

As with FIG. 5 described above, the embodiment of the mounting bracket 30 shown in FIG. 6 encloses a portion of the curtain airbag 12 between the front face 32 and the rear face 34. The one or more fasteners 36 pass through the mounting bracket 30 via the first opening 46 and the second opening 48. The fasteners 36 also pass through the curtain airbag 12 via the one or more holes 60.

As the fasteners 36 pass through the mounting bracket 30, the fasteners 36 engage the retaining members 50. More specifically, as the fasteners 36 pass through the mounting bracket 30, the fasteners 36 contact and/or push apart the retaining tabs 52 and cause the mounting bracket 30 to retain the fasteners 36. Thus, in the embodiment shown in FIG. 6, the fasteners 36 have contacted and/or pushed apart the retaining tabs 52 such that the retaining tabs 52 have become deformed.

Once the fasteners 36 have passed through the mounting bracket 30, the mounting bracket 30 with the enclosed curtain airbag 12 may then be added to the vehicle 10. This may be accomplished via the fasteners 36. More specifically, the retaining member 50 is constructed such that the fasteners 36 that pass through the bracket 30 may be easily rotated. Thus, the mounting of the bracket 30 with the enclosed airbag 12 and/or tethers 26 (shown in FIG. 1) may be accomplished by rotating and/or inserting the fasteners 36 into one or more apertures 62 that have been added to the vehicle 10. Additionally, the anti-rotation tabs 58 may also be inserted into apertures 62 in the vehicle 10.

Referring now to FIGS. 1-6 generally, the present invention also provides for an efficient method for installing a curtain airbag 12 and/or the tethers 26 to a vehicle 10. First one or more mounting brackets 30 are obtained. Next, the airbag 12 and/or the tethers 26 are secured to the mounting brackets 30. Preferably, this is accomplished by enclosing all or a portion of the airbag 12 and/or the tethers 26 between the front face 32 and the rear face 34. Lastly, the mounting brackets 30 (with the secured curtain airbag and/or the tethers 26) are mounted to the vehicle 10. Preferably, this is accomplished by inserting the fasteners 36 into one or more apertures 62 in the vehicle 10.

In summary, the present invention provides a mounting bracket that may be used to mount a curtain airbag and/or a tether to a vehicle. The mounting bracket is capable of retaining fastener and as a result, it eliminates the need for a retaining washer or other similar retaining feature.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A mounting bracket capable of retaining a fastener, the bracket comprising:
a front face;
a rear face positioned behind the front face;
a first opening located on the front face and a second opening located on the rear face, the first opening and the second opening constructed such that a fastener may pass through the bracket via the first opening and the second opening; and
a retaining member constructed such that when the fastener passes through the bracket, the fastener engages the retaining member and causes the bracket to retain the fastener.

2. The bracket as in claim 1 wherein the retaining member comprises retaining tabs, constructed such that when the fastener passes through the bracket, the fastener contacts the retaining tabs and causes the mounting bracket to retain the fastener.

3. The bracket as in claim 2 wherein the retaining member further comprises centering tabs.

4. The bracket as in claim 3 wherein the centering tabs are angled.

5. The bracket as in claim 4 wherein the centering tabs form an angle with respect to the rear face that is from about 45° to about 70°.

6. The bracket as in claim 2 wherein the retaining tabs are adjacent to the second opening.

7. The bracket as in claim 2 wherein the retaining tabs are angled.

8. The bracket as in claim 7 wherein the retaining tabs form an angle with respect to the rear face that is from about 3° to about 35°.

9. The bracket as in claim 1 wherein the bracket is constructed to mount an airbag to a vehicle.

10. The bracket as in claim 1 wherein the front face and the rear face are constructed to enclose a portion of an airbag.

11. The bracket as in claim 1 wherein the bracket is constructed to mount a tether to a vehicle.

12. The bracket as in claim 1 wherein the front face and the rear face are constructed to enclose a portion of a tether.

13. The bracket as in claim 1 further comprising an anti-rotation tab.

14. The bracket as in claim 13 wherein the anti-rotation tab is capable of being inserted into an aperture in a body of a vehicle.

15. The bracket as in claim 13 wherein the anti-rotation tab is attached to the rear face.

16. The bracket as in claim 13 wherein the anti-rotation tab is constructed such that if the bracket is mounted on a vehicle, the anti-rotation tab prevents the bracket from rotating.

17. An mounting bracket capable of retaining a fastener that may be used to mount an airbag or a tether to a vehicle, the mounting bracket comprising:
a front face;
a rear face positioned behind the front face;
a first opening located on the front face and a second opening located on the rear face, the first opening and the second opening constructed such that a fastener may pass through the bracket via the first opening and the second opening; and
a retaining member comprising retaining tabs, the retaining tabs constructed such that when the fastener passes through the bracket, the fastener pushes apart the retaining tabs and causes the bracket to retain the fastener.

18. The bracket as in claim 18 wherein the retaining member further comprises centering tabs.

19. The bracket as in claim 18 wherein the centering tabs guide the fastener to ensure that the fastener pushes apart the retaining tabs.

20. The bracket as in claim 18 wherein the centering tabs are angled.

21. The bracket as in claim 20 wherein the centering tabs form an angle with respect to the rear face that is from about 45° to about 70°.

22. The bracket as in claim 17 wherein the retaining tabs are angled.

23. The bracket as in claim 22 wherein the retaining tabs form an angle with respect to the rear face that is from about 3° to about 35°.

24. The bracket is a claim 17 wherein the bracket is constructed to mount an airbag to a vehicle.

25. The bracket as in claim 17 wherein the bracket is constructed to mount a tether to a vehicle.

26. The bracket as in claim 17 wherein the bracket is made of steel.

27. The bracket as in claim 17 wherein the bracket is made of pre-coated steel.

28. The bracket as in claim 17 further comprising an anti-rotation tab.

29. The bracket as in claim 28 wherein the anti-rotation tab is capable of being inserted into an aperture in a vehicle.

30. The bracket as in claim 28 wherein the anti-rotation tab is constructed such that if the bracket is mounted to a vehicle, the anti-rotation tab prevents the bracket from rotating.

31. The bracket as in claim 17 further comprising a closing tab.

32. The bracket as in claim 31 further comprising an aperture positioned adjacent to the closing tab.

33. The bracket as in claim 31 further comprising a slit on the on the rear face, the slit being constructed to receive the closing tab.

34. The bracket as in claim 17 further comprising an extending flange attached to the front face.

35. The bracket as in claim 17 further comprising a depression.

36. The bracket as in claim 17 wherein the bracket is constructed such that it is capable of enclosing a portion of an airbag between the front face and the rear face.

37. The bracket as in claim 17 wherein the bracket is constructed such that it is capable of enclosing a portion of a tether between the front face and the rear face.

38. A method for installing an airbag to a vehicle comprising:
obtaining a mounting bracket, the mounting bracket comprising a front face, a rear face positioned behind the front face, a first opening located on the front face and a second opening located on the rear face, the first opening and the second opening constructed such that a fastener may pass through the bracket via the first opening and the second opening, and a retaining member constructed such that when the fastener passes through the bracket, the fastener engages the retaining member and causes the bracket to retain the fastener;
securing the airbag to the bracket; and
mounting the bracket to the vehicle.

39. A method as in claim 38 wherein the mounting step comprises inserting the fastener into an aperture in the vehicle.

40. A method as in claim 38 wherein the securing step comprises enclosing a portion of the airbag within the bracket.

41. A method for installing a tether to a vehicle via comprising:
obtaining a mounting bracket, the mounting bracket comprising a front face, a rear face positioned behind the front face, a first opening located on the front face and a second opening located on the rear face, the first opening and the second opening constructed such that a fastener may pass through the bracket via the first opening and the second opening, and a retaining member constructed such that when the fastener passes through the bracket, the fastener engages the retaining member and causes the bracket to retain the fastener;
securing the tether to the bracket; and
mounting the bracket to the vehicle.

42. A method as in claim 41 wherein the mounting step comprises inserting the fastener into an aperture in the vehicle.

43. A method as in claim 41 wherein the securing step comprises enclosing a portion of the tether within the bracket.
